(19) United States
(12) Patent Application Publication
(10) Pub. No.: US 2011/0153397 A1
(43) Pub. Date: Jun. 23, 2011

(54) AWARDING AN INCENTIVE BASED ON PARAMETERS OF AN INCENTIVE PROGRAM

(76) Inventor: Jerold I. Wagenheim, Aventura, FL (US)

(21) Appl. No.: 12/643,657

(22) Filed: Dec. 21, 2009

(51) Int. Cl. G06Q 30/00; G06Q 10/00

(52) U.S. Cl. 705/14.13; 705/14.27; 705/14.3; 705/14.35

(57) ABSTRACT

Systems, methods and articles of manufacture are disclosed for awarding an incentive to a customer. An incentive program may be tailored to suit the needs of a merchant. The incentive program may be provided to a customer to reward specific customer behavior, such as regularly visiting a brick-and-mortar store to purchase store credit and/or to spend store credit and/or rewards, thereby providing the opportunity for increased sales for the merchant.

### BACKGROUND OF THE INVENTION

1. Field of the Invention

Embodiments of the invention relate to awarding an incentive to customers. More specifically, embodiments of the invention relate to awarding customers for accumulating store credit in a manner specified by an incentive program.

2. Description of the Related Art

Merchants often maintain customers, increase customer loyalty, and increase customer purchases by offering incentive programs. Incentive programs come in a variety of forms. Some incentive programs offer discounts on current purchases, while other incentive programs offer coupons for future purchases. Still other incentive programs offer non-monetary incentives, such as free airline tickets, hotel stays, food, and/or other merchandise.

Some incentive programs may also be associated with a holiday shopping season such as Christmas. These incentive programs typically increase customer purchases for the merchant during the associated holiday shopping season. However, the number of participating customers in the incentive program (and/or the increase in customer purchases by virtue of the incentive program) may be less than satisfactory to a merchant. Further, merchants may also desire to increase customer purchases during the non-holiday times of the year.

### SUMMARY OF THE INVENTION

Embodiments of the invention generally provide techniques for incentivizing customer visits to a brick and mortar store of one or more merchants. In some embodiments, the brick and mortar store of one or more merchants may be a predefined store or to a predefined group of stores, such as stores commonly owned by an entity, designated stores within a shopping complex, e.g., a shopping mall, stores that are members of a common organization, such as a chamber of commerce or trade association, or stores within a designated geographical area, such as a municipality, business district, country or state. Some embodiments may incentivize purchase of credit during visits to the brick and mortar store of the one or more merchants. The credit may be for use with a predefined one of the one or more merchants, or for use with a predefined group of merchants. In some embodiments, an incentive may be provided to utilize the credit with one or more predefined merchants preferentially over other merchants accepting the credit. In yet other embodiments, techniques for incentivizing customer visits to a brick and mortar store may utilize combinations of the embodiments summarized above.

One embodiment of the invention includes a method. The method may include configuring one or more computer processors to perform an operation. The operation may generally include providing an incentive program. The incentive program may include a first period of time for accumulating store credit to be spent only during a second period of time subsequent to the first period of time; the second period of time for spending the accumulated store credit; and one or more incentive rules that each define (i) a behavior criteria for accumulating the store credit from visits to a brick-and-mortar store during the first period of time and/or spending store credit during the second period of time, and (ii) a corresponding incentive reward. The operation may further include executing, by operation of one or more computer processors, an incentive amount calculator to determine an amount of an incentive reward to award to a customer according to an extent to which a behavior pattern of the customer satisfies the one or more incentive rules and awarding the determined amount of the incentive reward to the customer.

Another embodiment of the invention includes a computer-readable storage medium containing a program, which, when executed on a processor, performs an operation. The operation may generally include accessing an incentive program. The incentive program may include a first period of time for accumulating store credit to be spent only during a second period of time subsequent to the first period of time; the second period of time for spending the accumulated store credit; and one or more incentive rules that each define (i) a behavior criteria for accumulating the store credit from visits to a brick-and-mortar store during the first period of time and/or spending store credit during the second period of time, and (ii) a corresponding incentive reward. The operation may further include executing, by operation of one or more computer processors, an incentive amount calculator to determine an amount of an incentive reward to award to a customer according to an extent to which a behavior pattern of the customer satisfies the one or more incentive rules and awarding the determined amount of the incentive reward to the customer.

Still another embodiment of the invention includes a system having a computer processor and a memory containing a program, which when executed by the computer processor is configured to perform an operation. The operation may include accessing an incentive program. The incentive program may include: (a) a first period of time for accumulating store credit to be spent only during a second period of time subsequent to the first period of time; (b) the second period of time for spending the accumulated store credit; and (c) one or more incentive rules that each define (i) a behavior criteria for accumulating the store credit from visits to a brick-and-mortar store during the first period of time and/or spending store credit during the second period of time, and (ii) a corresponding incentive reward. The operation may further include determining an amount of an incentive reward to award to a customer according to an extent to which a behavior pattern of the customer satisfies the one or more incentive rules and awarding the determined amount of the incentive reward to the customer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for awarding an incentive to a customer, according to one embodiment of the invention.

FIG. 2 illustrates an incentive program, according to one embodiment of the invention.

FIGS. 3A-3B each illustrate a transaction history, according to one embodiment of the invention.

FIGS. 4A-4B each illustrate an account, according to one embodiment of the invention.

FIG. 5 is a flowchart depicting a method for awarding an incentive to a customer based on the incentive program, according to one embodiment of the invention.

FIG. 6 is a flowchart depicting a method for determining the amount of the incentive to award to the customer, according to one embodiment of the invention.

### DETAILED DESCRIPTION

Embodiments of the present invention generally provide techniques for increasing customer visits and/or purchases at stores of one or more merchants. One embodiment of the invention provides an incentive program. The merchant may offer the incentive program to customers. The merchant may reward customers for accumulating store credit in a manner specified by the incentive program. In other words, the merchant may encourage specific customer behavior, such as regularly visiting a brick-and-mortar store to purchase more and/or spend store credit. For example, the merchant may provide an incentive for visiting a brick-and-mortar store of the merchant on a predefined regular basis (e.g., weekly, monthly or other predefined time period) to purchase store credit. In another example, the merchant may provide an incentive for spending store credit a predefined brick-and-mortar store or stores preferentially over spending the credit remotely (e.g., without visiting the brick-and-mortar store for the purchase) or spending the credit at another store. Advantageously, the merchant may provide the incentive program to increase store sales and/or customer loyalty.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

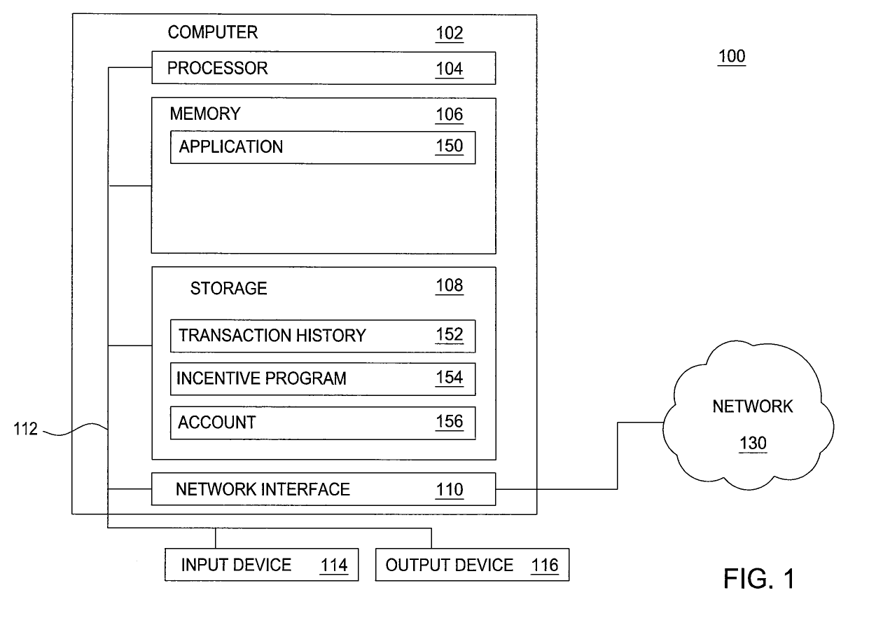

FIG. 1 is a block diagram illustrating a system 100 for awarding an incentive to a customer, according to one embodiment of the invention. The networked system 100 includes a computer 102. The computer 102 may be connected to other computers via a network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of an operating system. Examples of operating systems include UNIX, versions of the Microsoft Windows® operating system, and distributions of the Linux® operating system. (Note: Linux is at trademark of Linus Torvalds in the United States and other countries.) More generally, any operating system supporting the functions disclosed herein may be used. The processor 104 may be representative of a single CPU, multiple CPUs, a single CPU having multiple processing cores, and the like. Similarly, the memory 106 may be a random access memory. While the memory 106 is shown as a single entity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The storage 108 may be a hard disk drive storage device. Although the storage 108 is shown as a single unit, the storage 108 may be a combination of fixed and/or removable storage devices, such as fixed disc drives, floppy disc drives, tape drives, removable memory cards, or optical storage. The memory 106 and the storage 108 may be part of one virtual address space spanning multiple primary and secondary storage devices.

The input device 114 may be any device for providing input to the computer 102. For example, a keyboard, keypad, light pen, touch-screen, track-ball, or speech recognition unit, audio/video player, and the like may be used. The output device 116 may be any device for providing output to a user of the computer 102. For example, the output device 116 may be any conventional display screen or set of speakers, along with their respective interface cards, i.e., video cards and sound cards. Although shown separately from the input device 114, the output device 116 and input device 114 may be combined. For example, a display screen with an integrated touch-screen, a display with an integrated keyboard, or a speech recognition unit combined with a text speech converter may be used.

As shown, the memory 106 of the computer 102 includes an application 150. The storage 108 of the computer 102 includes a transaction history 152, an incentive program 154, and an account 156.

In one embodiment, the application 150 may be any software application that determines an amount of an incentive reward to award to a customer under an incentive program 154 of a merchant. To this end, the application may include an incentive amount calculator which uses parameters (described in more detail below) from the incentive program 154 to calculate the appropriate incentive reward. The application 150 may also award the determined amount of the incentive to the customer. As used herein, merchants include any entity such as retail stores, chain stores, discount stores, department stores, food stores, and other entities that sell their own and/or third party products and/or services via brick-and-mortar stores. Merchants may also sell their own and/or third party products and/or services remotely from brick-and-mortar stores via catalogues, mail order, telemarketing, and/or via Internet website(s) or other method. The incentive program may be administered and/or marketed by a merchant or by another entity on behalf of the merchant.

A number of methods may be utilized to indicate that a customer is participating in the incentive program. For example, the customer may be associated as participating in the incentive program by a user name identifiable by the application 150, a membership card, an radio-frequency (RF) tag or other means.

In one embodiment, the incentive program 154 may specify parameters. The parameters may include a name for the incentive program, a first time period for accumulating store credit (referred to herein as the accumulating period), a second time period for spending accumulated store credit (referred to herein as the spending period), and one or more incentives reward rules. Each incentive reward rule may include a name and criteria for determining how much of the respective incentive to award to a customer. For example, each incentive reward rule may define (i) a behavior criteria for accumulating the store credit during the first period of time and/or spending store credit during the second period of time, and (ii) a corresponding incentive reward.

Behavior criteria for accumulating the store credit may include one or more behavior criteria such as a) regularly visiting to purchase store credit at a predefined brick-and-mortar store or predefined group of brick-and-mortar stores over a time period; b) the frequency that store credit is purchased during the time period c) spending the store credit (and/or incentive award) at a predefined brick-and-mortar store or predefined group of brick-and-mortar stores preferentially over spending the credit remotely; and d) spending the store credit (and/or incentive award) at a predefined brick-and-mortar store or predefined group of brick-and-mortar stores preferentially over spending the credit at other brick-and-mortar store or stores. Store credit may be of the type only acceptable by a predefined merchant, or acceptable by a predefined group of merchants. For example, the incentive program 154 may specify an accumulating period (first period) of “forty-eight weeks prior to Christmas to four weeks prior to Christmas.” That is, a customer is only permitted to accumulate store credit in a time period between forty-eight weeks prior to Christmas and four weeks prior to Christmas. Further, the incentive program 154 may specify a spending period (second period) of “four weeks ending on Christmas.” That is, the customer is only permitted to spend the accumulated store credit, plus any awarded incentive, in the four weeks ending on Christmas. Of course, those of ordinary skill in the art will recognize that the accumulating period and the spending period may be tailored to suit the needs of a particular case. For example, the accumulating period and/or spending period may include any holiday, anniversary, occasion, event, or arbitrary time period.

Further, the incentive program 154 may specify an incentive reward to award the customer for purchasing store credit regularly (referred to herein as the regularity incentive) at a predefined brick-and-mortar store or stores. To trigger the regularity incentive, each store credit purchasing event must occur at least once during a predefined time interval, wherein a plurality of the predefined time intervals comprise a portion or all of the first predefined time period. For example, the incentive program 154 may award incentive based on the number of intervals in which the customer makes at least one visit to the predefined brick-and-mortar store and purchases store credit. The incentive program 154 may also set the dollar amount of store credit required to be purchased during each interval, which may be satisfied via a single or multiple purchases during the predefined time internal. For example, the regularity incentive may specify to award the customer with twenty percent of the accumulated store credit at the end of the accumulating period, provided that the customer purchases at least a threshold credit, for example ten dollars in store credit, every interval, such as a week, during the accumulating period. The regularity incentive may also specify that each “missed” interval (i.e., each week in which the customer does not purchase at least ten dollars in store credit) at the brick-and-mortar store results in a redefined award reduction and/or not award contribution for that interval. In some embodiments of the incentive program 154, a predefined number of allowances may be provided to compensate for not visiting the brick-and-mortar store to purchase store credit. The allowances may treat the “missed” interval as meeting the regularity requirements for that interval, or adjust the computation of the incentive award in a predefined manner, such as awarding a reduced or no incentive for the missed interval. Additionally, “allowances” for “missed” intervals wherein store credit was purchased remotely from the brick-and-mortar store may be treated with more favorable incentive award computation than allowances for “missed” intervals where no store credit was purchased, such as awarding a reduced incentive for the missed interval which is greater than a reduced incentive for a missed interval wherein no store credit was purchased. Further, the regularity incentive may specify that the customer must have no more than a predefined number of missed intervals to receive the incentive award. In other words, if the customer has, for example, six or more missed weeks during the accumulating period, then the merchant is not obligated to award the customer with any incentive. However, the merchant is not precluded from providing some type of incentive to the customer, despite the six or more missed weeks during the accumulating period.

Of course, those of ordinary skill in the art will recognize that the way to accumulate store credit may be tailored to suit the needs of a particular case. In one embodiment, the merchant may provide the incentive program in conjunction with a club or gift card. For example, the customer may purchase a ten-dollar gift card (e.g., store credit) at the predefined brick-and-mortar store(s) and visit the store weekly (e.g., the interval) to add ten dollars (e.g., the predefined amount) to the gift card. In one embodiment, if the customer cannot visit the brick-and-mortar store in a given week, the customer may visit a catalogue store or internet store of the merchant or, alternatively, call in or mail in to purchase store credit in the given week to obtain an allowance. In one embodiment, the incentive program 154 may impose a smaller penalty for a missed week if the customer at least purchases store credit via an internet store of the retailer. For example, purchasing store credit via an internet store of a retailer during a missed week may result in a one-half percent award reduction (rather than a one-percent award reduction). In this way the customer is provided some flexibility to balance the desire for accumulating the incentive rewards with the cost (both in terms of the time commitment and out-of-pocket expenses) of visiting a physical store. Further, in an alternative embodiment, rather than adding ten dollars to a gift card, the merchant may deactivate the gift card and provide a new gift card with the increased balance (i.e., by ten dollars) to the customer.

Similarly, the way to award the incentive to the customer may be tailored to suit the needs of a particular case. For example, in one embodiment, the application 150 may add the incentive reward to the account 156 associated with the customer and/or gift card. In an alternative embodiment, rather than adding the incentive reward to the account 156, the merchant may provide the customer with a coupon in an amount determined by the application 150. The incentive program may specify parameters for the coupon that are different from parameters for the purchased store credit (e.g., the spending period for the store credit and/or where and/or how the coupon may be spent). For example, in one embodiment, the customer may only use the coupon on December 1st, even though the purchased store credit may be used during the four weeks ending on Christmas day.

Advantageously, the merchant may provide the incentive program 154 to increase sales during the accumulating period. For example, a customer who finds the incentive attractive may opt to regularly and/or more frequently visit a brick-and-mortar store of the merchant to purchase store credit. Consequently, the customer may make fewer visits to—and purchases at—brick-and-mortar stores of (e.g., competing) merchants not participating in the incentive program (e.g., non-predefined merchants). The customer may instead make the purchases during a regular visit to the brick-and-mortar store of the merchant, thus increasing sales for the merchant during the accumulating period.

Further, the merchant may provide the incentive program 154 to increase sales during the spending period. For example, the incentive program 154 may include incentives that attract a greater number of participating customers and/or a greater amount of store credit purchased by the participating customers, thus increasing sales for the merchant during the spending period.

In one embodiment, to further increase sales during the accumulating period, the incentive program may specify to provide participating customers with discount coupons on merchandise purchased in conjunction with the purchase of store credit at the brick-and-mortar store. In one embodiment, merchandise may include, without limitation, flowers, jewelry, food, clothes, toys, electronics, books, games, music, movies, tools, furniture, home appliances, office supplies, sporting goods, musical instruments, health products, beauty products, insurance, travel, etc. For example, the merchant may provide the customer with weekly discount coupons that may vary in coupon value and/or targeted products, depending on what the merchant is interested in selling in a given week. In one embodiment, if a customer cannot visit a brick-and-mortar store during a given week, the merchant may provide the customer with a mail out coupon or a printable coupon.

In one embodiment, the incentive program 154 may specify that the customer is permitted to spend store credit during the accumulating period, provided that the customer is willing to accept a reduced incentive amount (or give up the incentive amount entirely).

In one embodiment, the incentive program 154 provides accommodations via allowances as discussed above for certain customers that are unable to visit a brick-and-mortar store. For example, customers unable to visit a brick-and-mortar store due to a physical or mental handicap may apply to participate in the incentive program either via mail, telephone, or the Internet. Similarly, such customers may purchase store credit via mail, telephone, or the Internet without any penalty in the amount of incentive awarded by increasing the number allowances provided in the incentive program 154 for customers identified as qualifying for an accommodation.

The incentive awarded may be awarded by addition to an account associated the customer, by increasing the value of the store credit purchased, by issuing a coupon or gift card or by other means. In one embodiment, the incentive award may be activated only at a predefined brick-and-mortar store.

In one embodiment, the customer may spend the store credit at any time during the spending period specified by the incentive program 154. The store credit may be spent in a predefined brick-and-mortar store or at a website of the predefined brick-and-mortar store of the merchant via the Internet. The customer may also spend the store credit in brick-and-mortar stores and/or at websites of another merchant that has made prior arrangements with the merchant regarding the incentive program 154. The value of the store credit may be greater if used at a brick-and-mortar store(s) of a first merchant or group of merchants designated from the predefined group of merchants than if used at the non-designated merchants. The value of the store credit may be greater if used at a brick-and-mortar store(s) of merchants than if remotely from the brick-and-mortar store(s). For example, the other merchant may be another retailer, catalogue, or website with which the merchant has a relationship to permit customers to purchase merchandise using store credit and/or awarded incentives, either in whole or in an adjusted manner. In one embodiment, the incentive program 154 specifies the merchants, brick-and-mortar stores, and/or websites at which a customer may purchase store credit, spend store credit, and/or spend the awarded incentive, and if any method or place of purchasing or spending store credit, or if any method or place of spending awarded incentive will adjust the value of the awarded incentive.

In one embodiment, the application 150 may analyze the transaction history to determine an amount of the incentive to be awarded to a customer under the incentive program 154. Continuing the above example involving a forty-eight week accumulating period, suppose that the transaction history indicates that the customer purchased ten dollars of store credit every week during the forty-eight week accumulating period. That is, the customer accumulates a balance of $480 of store credit by the end of the accumulating period. Because the customer did not miss any of the forty-eight weeks, the application 150 awards the customer the full incentive reward of twenty percent. For example, the application 150 may add $96 of store credit to the balance, for a total of $576. Advantageously, the customer receives the incentive reward and/or weekly discounts in return for participating in the incentive program, while the merchant increases sales as a result of providing the incentive program.

As another example, suppose that the transaction history indicates that the customer purchased ten dollars of store credit for forty-six out of the forty-eight weeks of the accumulating period. That is, the customer accumulates a balance of $460 of store credit by the end of the accumulating period. Because the customer missed two of the forty-eight weeks, the application 150 awards the customer a reduced incentive of eighteen percent (i.e., with each missed week reducing the incentive by one percent). For example, the application 150 may add $82.80, for a total of $542.80.

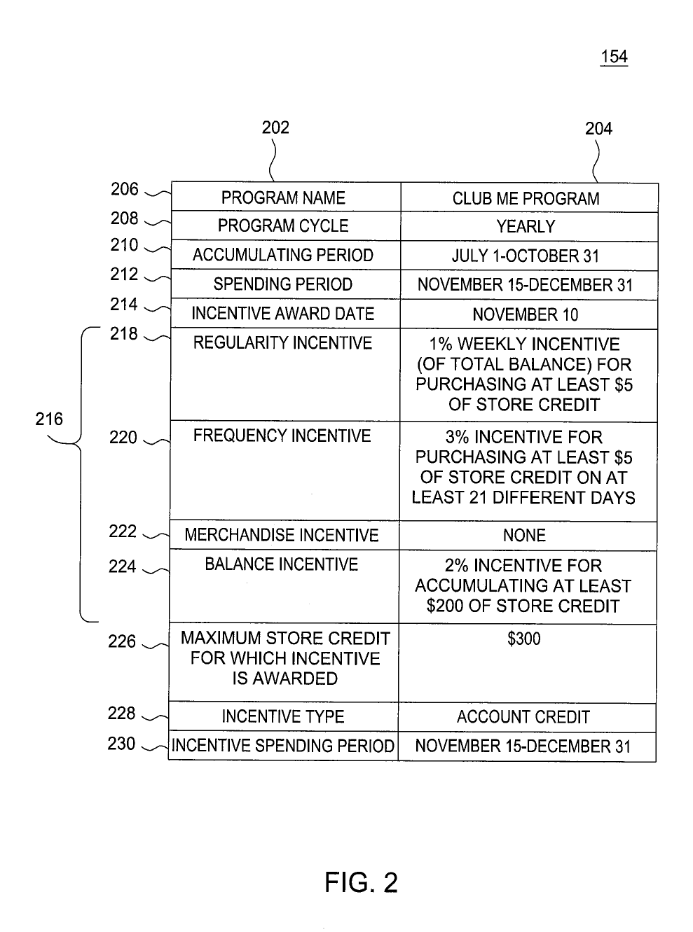

As described above, the incentive program 154 may specify parameters, according to one embodiment. Each parameter defines an aspect of the incentive program 154. FIG. 2 illustrates an exemplary incentive program, according to one embodiment of the invention. As shown, the incentive program 154 includes parameters, each parameter having a name 202 and a value 204. In this particular example, the parameters include a program name 206, a program cycle 208, an accumulating period 210, a spending period 212, an incentive award date 214, incentives 216, a maximum amount 226 of store credit for which the incentive is awarded, an incentive type 228, and an incentive spending period 230. The incentives 216 include a regularity incentive 218, a frequency incentive 220, a merchandise incentive 222, and a balance incentive 224.

In the particular example illustrated in FIG. 2, the incentive program is named the “Club Me Program.” Further, the incentive program is a yearly program having an accumulating period of July 1 to October 31 and having a spending period of November 15 to December 31. The incentive program specifies an award date of November 10. The incentive program includes several incentives: a “regularity incentive,” a “frequency incentive,” and a “balance incentive.” However, the incentive program does not include a “merchandise incentive.” In this particular example, the regularity incentive specifies predefined criteria for rewarding a customer for visiting a predefined brick-and-mortar store(s) regularly during predefined intervals to purchase store credit. The frequency incentive specifies predefined criteria for rewarding the customer for visiting the predefined brick-and-mortar store(s) frequently to purchase store credit, for example, the number of times the brick-and-mortar is visited during a specific interval. The balance incentive specifies predefined criteria for rewarding the customer for accumulating a specific balance in store credit from visiting the predefined brick-and-mortar store(s). The merchandise incentive specifies predefined criteria for rewarding the customer for purchasing store merchandise in conjunction with store credit when visiting the predefined brick-and-mortar store(s).

Of course, those of ordinary skill in the art will recognize that the names, number, and types of incentives included in an incentive program may be tailored to suit the needs of a particular case. For example, the incentive program may include a 1% “charging incentive” for purchasing at least $50 of store credit on a single visit to a brick-and-mortar store. Generally, the incentive program may include any number of incentives, each designed to reward a predefined pattern of customer behavior (e.g., at a brick-and-mortar store of the merchant).

In this particular example, the regularity incentive includes a 1% weekly incentive for purchasing at least $5 store credit (for each given week). The 1% may be computed based on total accumulated store credit by the end of the accumulating period. Further, the frequency incentive includes a 3% incentive for purchasing at least $5 of store credit on at least twenty-one different days during the accumulating period. The balance incentive includes a 2% incentive for having accumulated at least $200 of store credit at the end of the accumulating period. As described above, the incentive program 154 in this particular example does not include the merchandise incentive. An example of the merchandise incentive includes an additional %1 weekly incentive for purchasing at least $20 of merchandise in conjunction with store credit (for each given week).

Further, the maximum store credit for which the incentive is awarded is $300. That is, if a customer accumulates $550 of store credit and is entitled to a 10% incentive under the incentive program 154, the 10% incentive is applied to $300 of the $550, rather than the entire $550. That is, the customer receives a $30 incentive, for a total balance of $580 in store credit.

As shown, the incentive type is account credit (e.g., rather than coupon, etc.). Further, the incentive spending period 230 coincides with the spending period 212 in this particular example: November 15 to December 31. In an alternative embodiment, the incentive spending period 230 may be different from the spending period 212. For example, suppose the merchant wants to offer the incentive in the form of a coupon for consumer electronics, valid only on the first day of December. In such a case, the incentive type may be “coupon” and the incentive spending period may be “December 1.”

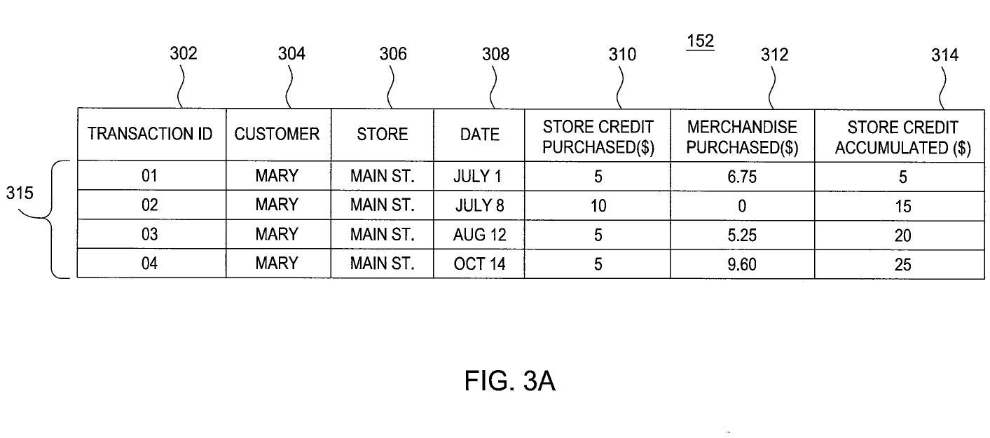

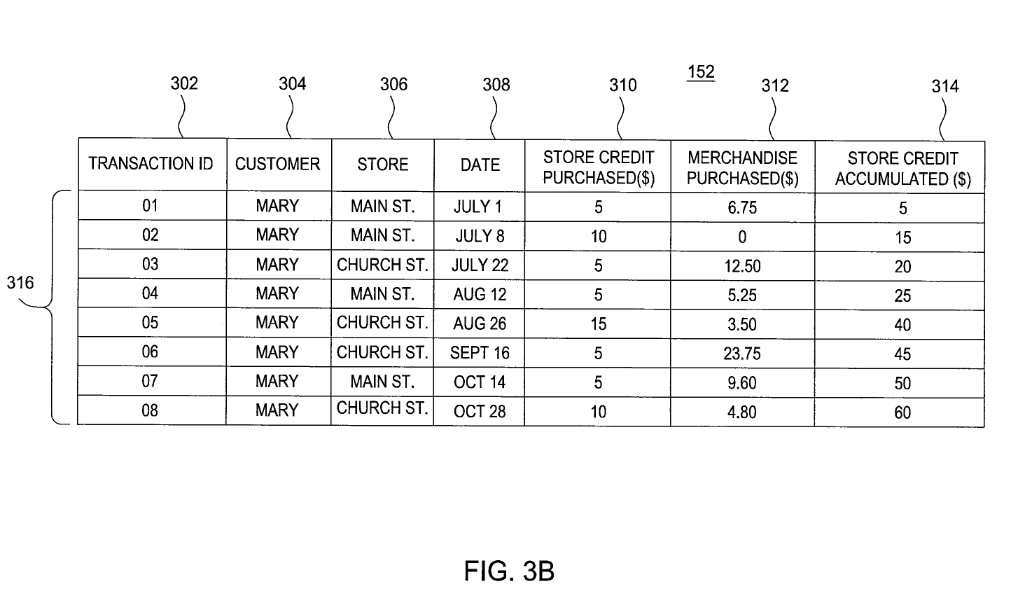

In one embodiment, the application 150 may analyze the transaction history 152 to determine an amount of the incentive to award a customer, according to one embodiment. FIGS. 3A-3B each illustrate an exemplary transaction history, according to one embodiment of the invention. As shown in FIG. 3A, the transaction history 152 includes transaction records 315. Each record 315 includes fields. In this particular example, the fields include a transaction ID 302, a customer 304, a store 306, a date 308, an amount 310 of purchased store credit, an amount 312 of purchased merchandise, and an amount 314 of accumulated store credit. Of course, those of ordinary skill in the art will recognize that the way of representing transactions using records and fields may be tailored to suit the needs of a particular case.

As shown in FIG. 3A, the transaction history 152 indicates that an exemplary customer Mary conducted four transactions at a predefined brick-and-mortar store (namely, Main Street store). Specifically, the transaction history 152 indicates that Mary purchased $5 of store credit and $6.75 of merchandise on July 1. Further, Mary purchased $10 of store credit on July 8. On August 12, Mary purchased $5 of store credit and $5.25 of merchandise. On October 14, Mary purchased $5 of store credit and $9.60 of merchandise, for a total balance of $25 in accumulated store credit.

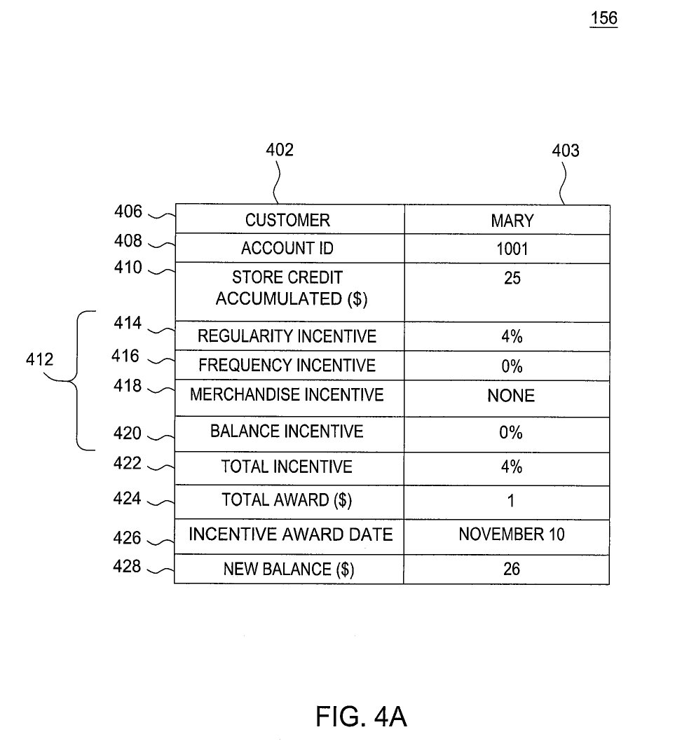

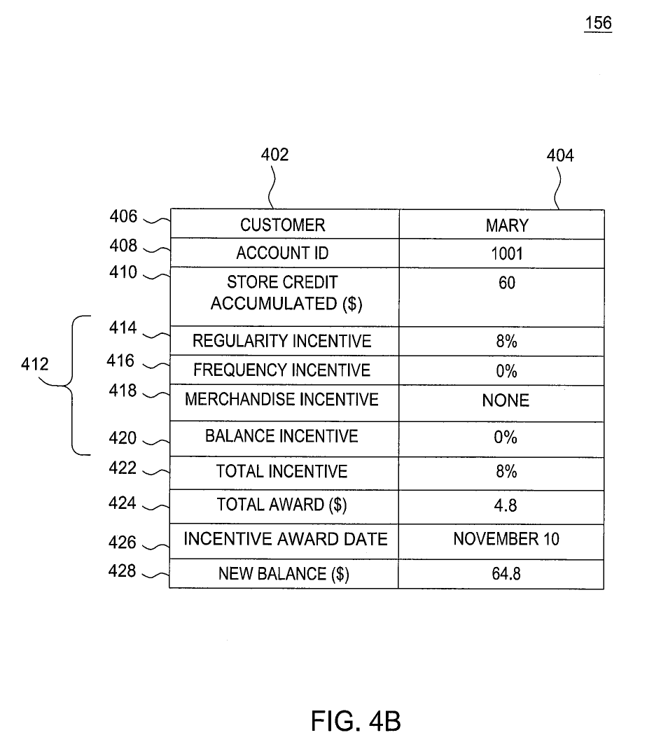

In one embodiment, the application 150 may determine an amount of the incentive reward to award to the customer based on the incentive program 154 and the transaction history 152. Further, the application 150 may award the determined amount of the incentive to the customer. For example, the application 150 may update an account 156 of the customer to reflect the awarded incentive. FIGS. 4A-4B each illustrate an exemplary account 156, according to one embodiment of the invention. FIG. 4A illustrates an account that is associated with the transaction history 152 of FIG. 3A. As shown in FIG. 4A, the account 156 includes fields 402 and corresponding field values 403. In this particular example, the fields 402 include a customer 406, an account ID 408, an amount 410 of accumulated store credit, incentives 412, a total incentive 422, a total award 424, an incentive award date 426, and a new balance 428. The incentives 412 may include a regularity incentive 414, a frequency incentive 416, a merchandise incentive 418, and a balance incentive 420.

For example, the application 150 may determine the incentives 412 to award to the customer. For instance, because Mary conducted a total of four weekly transactions (as shown in FIG. 3A), the application 150 may determine to award an 4% regularity incentive to Mary (based on the regularity incentive 218 of FIG. 2). Further, because Mary did not purchase at least $5 of store credit on at least twenty-one different days (Mary only purchased store credit on four different days), the application 150 may determine not to award any frequency incentive to Mary (based on the frequency incentive 220 of FIG. 2). Further, because the incentive program 154 does not include a merchandise incentive (as shown in FIG. 2), the application 150 does not award any merchandise incentive to Mary. Further, because Mary did not accumulate at least $200 of store credit (Mary only accumulated $60 of store credit), the application 150 may determine not to award any balance incentive to Mary (based on the balance incentive 224 of FIG. 2).

That is, the application 150 may determine to award a total incentive of 4% to Mary on November 10 (as specified by the incentive program 154). In other words, the application 150 may add $1 of store credit to the balance of $25, for a new balance of $26 in store credit.

In one embodiment, the incentive program 154 may specify predefined brick-and-mortar stores such as a list of participating store locations, merchants, entities, or stores located in business districts, municipal entities, shopping complexes, sales regions, etc. For example, one incentive program may seek to increase local sales in a specific town or at a specific shopping mall. The incentive program may specify, as participating stores, only certain stores within the shopping mall. As another example, a second incentive program may include stores of affiliated entities in the list of participating stores. Accordingly, while the transaction history 152 of FIG. 3A includes transactions conducted at a single store, in one embodiment, the transaction history 152 may include transactions conducted at multiple participating stores/store locations (according to the incentive program 154).

For example, as shown in FIG. 3B, the transaction history 152 includes transaction records 316. Each record 316 includes fields. In this particular example, the fields include the transaction ID 302, the customer 304, the store 306, the date 308, the amount 310 of purchased store credit, the amount 312 of purchased merchandise, and the amount 314 of accumulated store credit. Further, the transaction history 152 indicates that Mary conducted eight transactions at brick-and-mortar stores. Specifically, the transaction history 152 indicates that Mary purchased $5 of store credit and $6.75 of merchandise at a Main Street store on July 1. Further, Mary purchased $10 of store credit at the Main Street store on July 8. On July 22, Mary purchased $5 of store credit and $12.50 of merchandise at a Church Street store. On August 12, Mary purchased $5 of store credit and $5.25 of merchandise at the Main Street store. On August 26, Mary purchased $15 of store credit and $3.50 of merchandise at the Church Street store. On September 16, Mary purchased $5 of store credit and $23.75 of merchandise at the Church Street store. On October 14, Mary purchased $5 of store credit and $9.60 of merchandise at the Main Street store. On October 28, Mary purchased $10 of store credit and $4.80 of merchandise at the Church street store, for a total balance of $60 in accumulated store credit.

FIG. 4B illustrates an exemplary account 156, according to one embodiment of the invention. FIG. 4B illustrates an account that is associated with the transaction history 152 of FIG. 3B. As shown, the account 156 includes fields 402 and corresponding field values 404. In this particular example, the fields 402 include the customer 406, the account ID 408, the amount 410 of accumulated store credit, the incentives 412, the total incentive 422, the total award 424, the incentive award date 426, and the new balance 428. The incentives 412 may include the regularity incentive 414, the frequency incentive 416, the merchandise incentive 418, and the balance incentive 420.

For example, the application 150 may determine the incentives 412 to award to the customer. For instance, because Mary conducted a total of eight weekly transactions (as shown in FIG. 3B), the application 150 may determine to award an 8% regularity incentive to Mary (based on the regularity incentive 218 of FIG. 2). Further, because Mary did not purchase at least $5 of store credit on at least twenty-one different days (Mary only purchased store credit on eight different days), the application 150 may determine not to award any frequency incentive to Mary (based on the frequency incentive 220 of FIG. 2). Further, because the incentive program 154 does not include a merchandise incentive (as shown in FIG. 2), the application 150 does not award any merchandise incentive to Mary. Further, because Mary did not accumulate at least $200 of store credit (Mary only accumulated $60 of store credit), the application 150 may determine not to award any balance incentive to Mary (based on the balance incentive 224 of FIG. 2).

That is, the application 150 may determine to award a total incentive of 8% to Mary on November 10 (as specified by the incentive program 154). In other words, the application 150 may add $4.8 of store credit to the balance of $60, for a new balance of $64.8 in store credit.

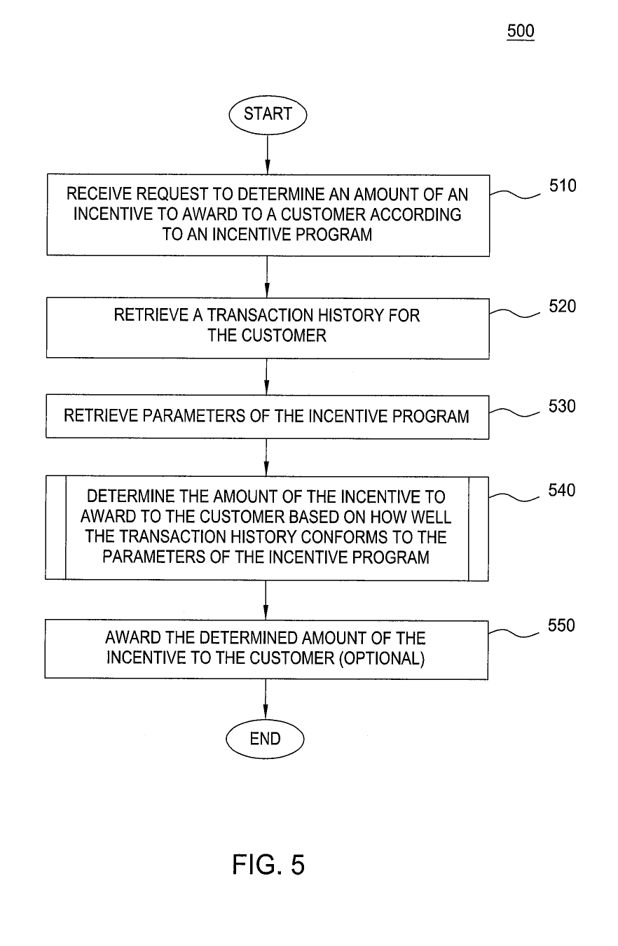

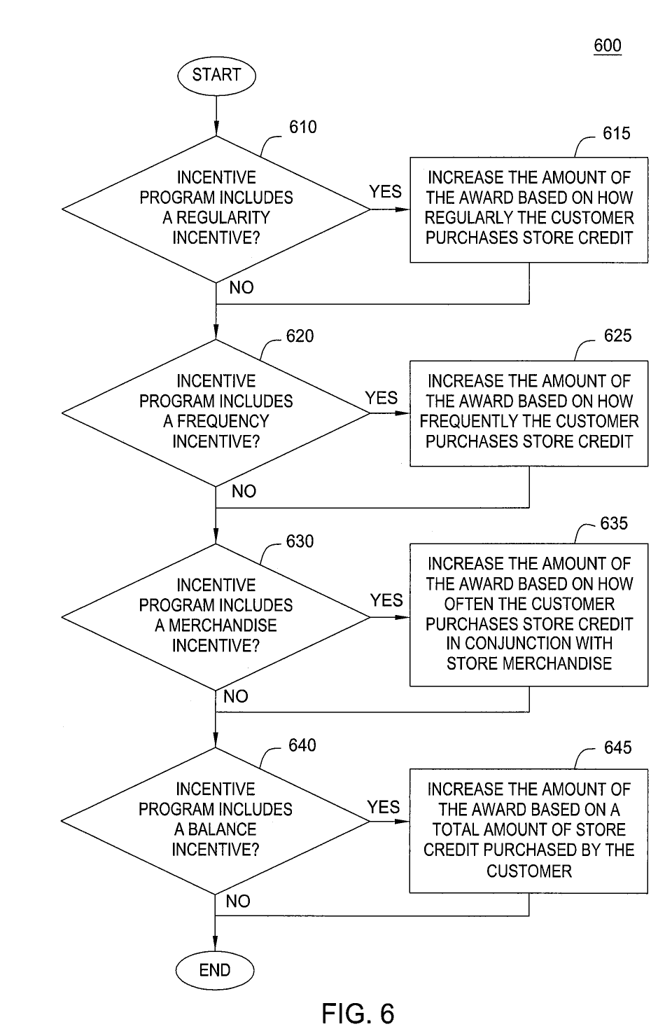

FIG. 5 is a flowchart depicting a method 500 for awarding an incentive to a customer based on an incentive program, according to one embodiment of the invention. As shown, the method 500 begins at step 510, where the application 150 receives a request to determine an amount of the incentive to award to the customer according to the incentive program (e.g., the incentive program 154 of FIG. 2). At step 520, the application 150 retrieves a transaction history for the customer (e.g., the transaction history 152 of FIG. 3B). At step 530, the application 150 retrieves parameters of the incentive program (e.g., program cycle, accumulating period, incentive type, etc.). At step 540, the application 150 determines the amount of the incentive to award to the customer based on how well the transaction history of the customer conforms to the parameters of the incentive program. The step 540 is further described below in conjunction with FIG. 6. At step 550, the application 150 may optionally award the determined amount of the incentive to the customer (e.g., by updating a balance of a customer account, adjusting store credit, by issuing a coupon to the customer and the like). After the step 550, the method 500 terminates.

FIG. 6 is a flowchart depicting a method 600 for determining the amount of the incentive to award to the customer, according to one embodiment of the invention. The method 600 corresponds to the step 540 of FIG. 5. As shown, the method 600 begins at step 610, where the application 150 determines whether the incentive program includes a regularity incentive. If so, the application 150 increases the amount of the incentive award based on how regularly the customer purchases store credit (step 615) at the predefined brick-and-mortar store, accounting for any allowances, over the intervals of the first period. For example, the application 150 may increase the amount of the incentive award based on the regularity incentive 218 of FIG. 2. Otherwise, the method 600 proceeds to step 620.

If the incentive program includes a frequency incentive (step 620), the application 150 increases the amount of the incentive award based on how frequently the customer purchases store credit (step 625) during a specific interval. For example, the application 150 may increase the amount of the incentive award based on the frequency incentive 220 of FIG. 2. Otherwise, the method 600 proceeds to step 630.

If the incentive program includes a merchandise incentive (step 630), the application 150 increases the amount of the incentive award based on how often the customer purchases store credit in conjunction with store merchandise (step 635). For example, the application 150 may increase the amount of the incentive award based on the merchandise incentive 222 of FIG. 2. Otherwise, the method 600 proceeds to step 640.

If the incentive program includes a balance incentive (step 640), the application 150 increases the amount of the incentive award based on a total amount of store credit accumulated by the customer (step 645). For example, the application 150 may increase the amount of the incentive award based on the balance incentive 224 of FIG. 2. After the step 645 or the step 640, the application 150 may also evaluate other any other incentives specified by the incentive program 154. When no incentives remain to be evaluated, the method 600 terminates.

In one embodiment, the incentive program 154 may also specify one or more spending rules. Each spending rule defines how the customer is permitted to spend the store credit and/or the incentive award. For example, the incentive program may include three spending rules. The incentive program may specify that the customer is permitted to spend the incentive award at one of: (i) a predefined brick-and-mortar store (the first spending rule); (ii) an online store of the merchant associated with the predefined brick-and-mortar store (the second spending rule); (iii) a brick-and-mortar store of not designated from among the group of predefined brick-and-mortar stores (the third spending rule); or (iv) a merchant outside of the group of predefined brick-and-mortar stores (the fourth spending rule). The amount of the incentive award may be adjusted preferentially for one spending rule over one or more of the other spending rules to provide additional incentive for the customer to visit the brick-and-mortar store of the selected merchants over the other merchants or on-line store of the merchant itself. Beneficially, by incentivizing the customer to visit a particular or particular group of brick-and-mortar stores preferentially over other merchants stores, increased customer purchases due to convenience and impulse buying, along with increased customer loyalty is generated.

Advantageously, embodiments of the invention provide techniques for awarding an incentive to a customer. In one embodiment, an application determines an amount of the incentive to award to the customer based on parameters of an incentive program and a transaction history of the customer. The parameters of the incentive program may be tailored to suit the needs of a merchant. The incentive program may specify an accumulating period and a spending period. By providing a tailored incentive program to customers, the merchant may increase sales during both the accumulating period and the spending period, while meeting any business needs (such as a need to sell a specific product or type of product).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

1. A computer-implemented method, comprising:
providing an incentive program that includes:
(a) a first predetermined period of time for accumulating store credit to be spent only during a second predetermined period of time subsequent to the first period of time; and
(b) one or more incentive rules that each define (i) a behavior criteria for accumulating the store credit from purchasing at least a predefined amount of store credit on a regular basis during the first period of time during visits to a predetermined brick-and-mortar store, and (ii) a corresponding incentive reward;
executing, by operation of one or more computer processors, an incentive amount calculator to determine an amount of the incentive reward to award to a customer according to an extent to which a behavior pattern of the customer satisfies the one or more incentive rules; and
awarding the determined amount of the incentive reward to the customer.

2. The computer-implemented method of claim 1, wherein the behavior criteria further includes spending store credit during the second period of time.

3. The computer-implemented method of claim 1, wherein the incentive reward is selected from at least one of store credit and a coupon.

4. (canceled)

5. The computer-implemented method of claim 1, wherein purchasing on the regular basis further comprises purchasing at least the predefined amount of store credit in each of at least two intervals defined during the first period of time, wherein the first period of time has at least N intervals, and wherein N is an integer greater than 1.

6. The computer-implemented method of claim 1, wherein the determined amount of the incentive reward is determined in response to the number of intervals in which store credit is purchased at the predetermined brick-and-mortar store.

7. The computer-implemented method of claim 6, further comprising:
counting an interval in which the customer did not visit the predetermined brick-and-mortar store the number in the number of intervals used to determine the amount of incentive reward if the customer has an unused allowance.

8. The computer-implemented method of claim 5, wherein awarding the determined amount of the incentive to the customer comprises increasing the determined amount of the incentive reward in response to a frequency of visits to the predetermined brick-and-mortar store during at least one interval.

9. A computer-readable storage medium containing a program, which, when executed on a processor, performs an operation comprising:
accessing an incentive program that includes:
(a) a first predetermined period of time for accumulating store credit to be spent only during a second predetermined period of time subsequent to the first period of time, the first period of time segmented into N predefined intervals of time, wherein N is an integer greater than 1;
(b) the second period of time for spending the accumulated store credit; and
(c) one or more incentive rules that each define (i) a behavior criteria for accumulating the store credit from purchasing at least a predefined amount of store credit on a regular basis during the first period of time during visits to a predetermined brick-and-mortar store and (ii) a corresponding incentive reward;
executing, by operation of one or more computer processors, an incentive amount calculator to determine an amount of the incentive reward to award to a customer according to an extent to which a behavior pattern of the customer satisfies the one or more incentive rules; and awarding the determined amount of the incentive reward to the customer which may only be spent during the second period of time.

10. The computer-readable storage medium of claim 9, wherein the amount of the incentive reward is determined in response to the number of intervals in which the customer visits the predetermined brick-and-mortar store.

11. The computer-readable storage medium of claim 9, wherein the amount of the incentive reward is determined based on at least one of where and how the incentive reward is spent.

12. The computer-readable storage medium of claim 9, wherein the one or more incentive rules includes an incentive rule that defines a behavior criteria comprising purchasing, at the predefined brick-and-mortar store, at least a predefined amount of store credit in at least two different intervals during the first period of time.

13. The computer-readable storage medium of claim 12, wherein predetermined brick-and-mortar store is one of a predetermined group of stores that are at least one of within a designated municipality, members of a common organization, owned by a common entity, or located in a designated shopping complex.

14. The computer-readable storage medium of claim 12, wherein the amount of the incentive reward is greater at a first group of the brick-and-mortar stores relative to a second group of the brick-and-mortar stores comprising the predetermined group of stores.

15. The computer-readable storage medium of claim 9, wherein the amount of the incentive reward is greater if spent at the predefined brick-and-mortar store than if spent remotely from the predefined brick-and-mortar store.

16. The computer-readable storage medium of claim 15, wherein the amount of the incentive reward is greater if spent utilizing a website of the predefined brick-and-mortar store than if spent at a non-predefined brick-and-mortar store.

17. A system, comprising:
a memory containing a program: and
a computer processor which, when executing the program is configured to perform an operation comprising:
accessing an incentive program that includes:
(a) a first predetermined period of time for accumulating store credit to be spent only during a second predetermined period of time subsequent to the first period of time, the first period of time segmented into N predefined intervals of time, wherein N is an integer greater than 1;
(b) the second period of time for spending the accumulated store credit; and
(c) one or more incentive rules that each define (i) a behavior criteria for accumulating the store credit from purchasing at least a predefined amount of store credit on a regular basis during the first period of time during visits to a predefined brick-and-mortar store and (ii) a corresponding incentive reward;
determining an amount of the incentive reward to award to a customer according to an extent to which a behavior pattern of the customer satisfies the one or more incentive rules; and
awarding the determined amount of the incentive reward to the customer.

18. The system of claim 17, wherein the incentive program further specifies that the amount of the incentive reward may only be spent during the second period of time.

19. The system of claim 17, wherein the incentive reward is selected from at least one of store credit and a coupon.

20. The system of claim 17, wherein the amount of the incentive reward is determined in response to the number of intervals in which the customer visits the predetermined brick-and-mortar store and purchases a predetermined amount of store credit.
